(19) United States
(12) Patent Application Publication
(10) Pub. No.: US 2011/0283609 A1
(43) Pub. Date: Nov. 24, 2011

(54) Apparatus and Method for Killing Unwanted Vegetation

(76) Inventor: John Leach, Winnipeg (CA)

(21) Appl. No.: 13/111,447

(22) Filed: May 19, 2011

Related U.S. Application Data
(60) Provisional application No. 61/346,219, filed on May 19, 2010.

(30) Foreign Application Priority Data
Mar. 16, 2011 (CA) 2,734,457

(51) Int. Cl. A01M 7/00

(52) U.S. Cl. 47/1.43

(57) ABSTRACT

Apparatus for killing unwanted vegetation using heated water comprises a refillable compressed air tank, a refillable water tank, a shut-off valve operably installed on a connection conduit between the compressed air tank and the water tank for select opening and closing of the conduit to respectively allow and prevent flow between the tanks, a flexible hose connected to the water tank, an applicator wand connected to the flexible hose opposite the water tank and comprising a rigid delivery conduit terminating at a discharge end of the applicator wand and a normally closed control valve on the applicator wand to selectively and temporarily open to control discharge of heated water from the water tank under air pressure from the air tank. The apparatus is used to inject heated water beneath a spot of ground surface from which unwanted vegetation has emerged

### CROSS REFERENCE TO RELATED APPLICATIONS

This application claims benefit under 35 U.S.C. 119(e) of U.S. Provisional Patent Application Ser. No. 61/346,219, filed May 19, 2010.

### FIELD OF THE INVENTION

The present invention relates generally to killing unwanted vegetation, and more particularly to apparatus and methods for weed control using targeted injection of heated water into the ground to damage the endosperm of individual weeds and thereby terminate the plants.

### BACKGROUND OF THE INVENTION

With rising concerns over environmental issues, current trends are leaning toward reduced use of chemical herbicides in weed control. For some time it has been known in the prior art to use steam or heated water to try and kill weeds, and a number of devices or machines have been developed to make use of this principle. U.S. Pat. Nos. 5,385,106, 5,927,601, 5,946,851 and 7,100,540, U.S. Patent Application Publication Number 2007/0176316, European Patent Application Number 1695620 and Japanese Patent Document Numbers 7-163285 and 2002-065138 teach examples of such water or steam-based prior art solutions.

However, some of these prior art solutions include use of large equipment and vehicle-based systems that do not lend well to small scale use by individual home owners for personal lawn maintenance, configurations that apply steam or heated water in an above ground context that may inadvertently damage surrounding vegetation or may not adequately treat the subsurface element of the weeds to prevent the unwanted vegetation from re-emerging, and configurations that, while small enough for portable or personal use, require on board electrical sources or combustible fuel to heat and convey the water. Combustion-based tools can be expensive to operate, emit harmful exhaust fumes and present risk of explosion or fire. While battery technology has dramatically improved in recent years, some consumers are hesitant to purchase battery operated yard care tools in view of the potential lose of ability to maintain the battery's original level of charge after repeated uses, leading to reduced performance or need for replacement battery packs.

Accordingly, there remains room for improvement in this field, and applicant has now developed a unique solution that addresses shortcomings of the prior art.

### SUMMARY OF THE INVENTION

According to a first aspect of the invention there is provided an apparatus for killing unwanted vegetation using heated water, the apparatus comprising:

a refillable compressed air tank;

a refillable water tank connected to the refillable compressed air tank by a connection conduit and having an openable and closeable fill opening for filling of the water tank;

a shut-off valve operably installed on the connection conduit between the compressed air tank and the water tank for select opening and closing of the conduit to respectively allow and prevent flow between the tanks;

a flexible hose having a first end thereof connected to the water tank;

an applicator wand connected to a second end of the flexible hose opposite the water tank and comprising a rigid delivery conduit terminating at a discharge end of the applicator wand spaced along the wand from a connection of the flexible hose thereto, the flexible hose and the rigid delivery conduit being fluidly coupled together in a sealed condition to allow flow from the flexible through the rigid delivery conduit for exit therefrom at the discharge end of the applicator wand; and

a normally closed control valve operable to selectively and temporarily open from a normally closed position blocking flow through the flexible hose and the rigid conduit to control discharge of heated water from the water tank under air pressure from the air tank.

Preferably there is provided an electric heater device mounted on the water tank and operable to heat water contained therein.

Preferably the electric heater device is arranged to be powered by an external power source separate and distinct from the apparatus.

Preferably the electric heater device comprises a power cord equipped with a male plug at an end thereof opposite the water tank to mate with a female mains power socket for operation of the heater device.

Preferably the electric heater device comprises an electric element disposed within an interior of the water tank.

Preferably there is provided an indicator device on the water tank operable to indicate when the water contained in the water tank has been heated sufficiently for use of the apparatus.

The indicator device may comprise a steam whistle providing an audible indication when the water has reached a boil. In this instance, preferably there is also provided a whistle valve operable to open and close a passage between the interior of the water tank and the whistle to enable closing of the water tank after the water has boiled but before the shut off valve is opened to expose the water to pressure from the compressed air tank.

Preferably there is provided a support feature by which the compressed air and water tanks can be carried by an operator.

Preferably the support feature comprises straps by which the tanks can be worn on the back of the operator.

The straps may be part of a back pack on which the compressed air and water tanks are carried.

The wand preferably comprises an outer wall closing around the rigid conduit over at least a partial length thereof.

There may be provided reinforcements mounted between the rigid conduit and an end of the outer wall from which a portion of the rigid conduit projects to the discharge end to reinforce said portion of the rigid conduit during piercing thereof into ground to inject heated water thereto.

Alternatively, there may be provided a socket fixed to the wand in a position closing around the rigid conduit at the discharge end of the wand and projecting past the discharge end of the wand so that the rigid conduit discharges into a hollow interior of the socket. The socket may extend from and end of the outer wall adjacent the discharge end of the wand, the socket being smaller in outer diameter than the outer wall.

Preferably the socket extends at least ¼-inch past the discharge end of the wand.

Preferably the socket extends at least ½-inch past the discharge end of the wand.

Preferably the socket extends between ¼-inch and ¾-inch past the discharge end of the wand.

Preferably the wand comprises a foot projection extending outward from a remainder of the wand at a position therealong proximate but spaced from the discharge end to present a feature against which an operator's foot can be pushed to drive the discharge end of the wand into a spot of ground at which undesired vegetation has grown.

Preferably the rigid conduit is between 1/16-inch and ¾-inch in diameter, inclusive. More preferably, the rigid conduit may be less than or equal to ½-inch in diameter. In one preferred embodiment, the rigid conduit is ¼-inch in diameter.

According to a second aspect of the invention there is provided a method for killing unwanted vegetation using heated water, the method comprising heating water and injecting the heated water beneath a spot of ground surface from which the unwanted vegetation has emerged.

Preferably the method includes injecting the heated water at a depth beneath ground surface at which an endosperm of the unwanted vegetation is disposed.

Preferably the method includes injecting the heated water at a depth of less than 2-inches beneath ground surface.

The method may include piercing a discharge end of an injector through ground surface to a depth below an endosperm of the unwanted vegetation, beginning to inject the heated water and continuing to inject the heated water while withdrawing the discharge end of the injector back toward the ground surface.

Preferably the method includes using the apparatus of the first aspect of the invention to inject the heated water by performing steps comprising opening the shut off valve to expose the heated water in the water tank to compressed air from the compressed air tank, piercing the discharge end of the wand into ground, and opening the normally closed control valve to release some of the heated water from the apparatus through the rigid conduit at the discharge end of the wand.

As the apparatus preferably includes a heating device, the method may include first powering the heating device to heat the water within the water tank.

### BRIEF DESCRIPTION OF THE DRAWINGS

In the accompanying drawings, which illustrate exemplary embodiments of the present invention:

FIG. 1 is a schematic illustration of a first embodiment weed killing apparatus having a refillable water tank with a plug-in heater for pre-heating water before use of the apparatus and a refillable compressed air tank as the power source to convey heated water to an applicator wand for injecting the heated water into the ground to directly attack the endosperm of a weed.

FIG. 2 is a schematic end view of the wand of FIG. 1 showing reinforcement of a delivery conduit through which water passes through the wand at a discharge end thereof by triangular reinforcement plates mounted between an end of a sleeve closing around most of the conduits length and the portion of the conduit that projects from the sleeve to present a piercing insertion end for driving into the ground to convey the heated water thereto.

FIG. 3 is a schematic partial cross-sectional view of the wand of a second embodiment weed killing apparatus.

### DETAILED DESCRIPTION

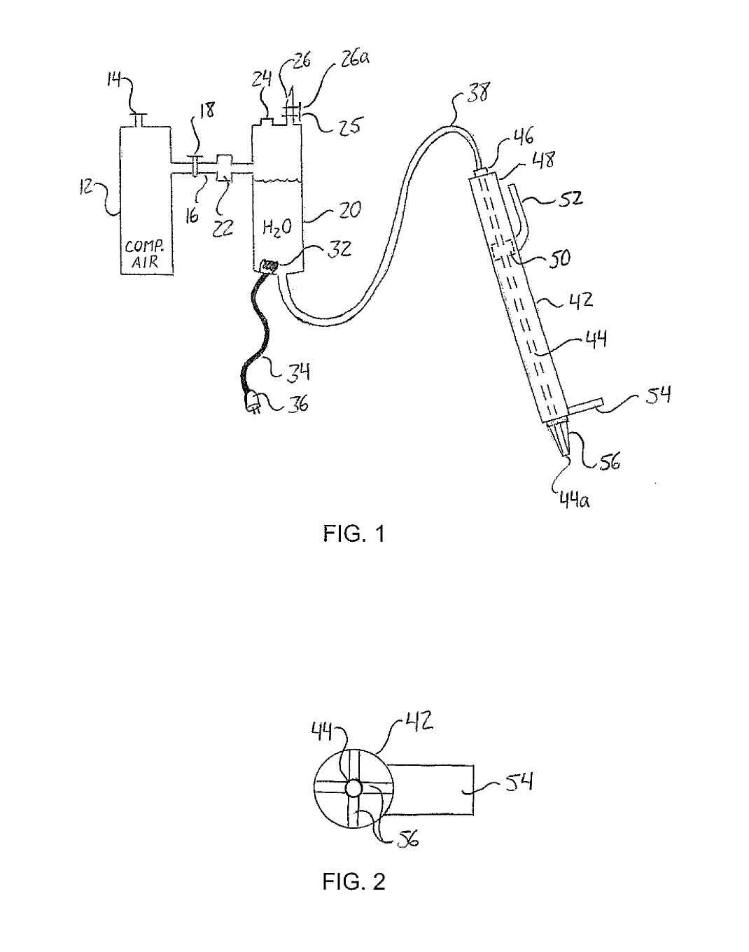

FIG. 1 shows a first embodiment weed killing apparatus that is used to effectively “cook” or “poach” the endosperm of a weed by injecting heated water into the ground at the weed's location at a depth at which the endosperm is situated beneath the surface. Weeds have an endosperm, from which the root grows down deeper into the ground and the stem grows up to break through the ground surface. Weeds tend to be resilient and may flourish in a variety of environmental conditions, but selectively “cooking” the endosperm, typically located

With reference to the drawings, the apparatus 10 or Weed Poacher, starting with the far left of FIG. 1, features an air tank 12 for storage of compressed air that can be obtained from a user's own air compressor or those typically made available for public use at local gas stations/garages. For safety, the tank may be pressure tested to a value above what will be required for operation of the apparatus, for example tested to 300 PSI, and feature a relief valve 14 set to a value below the tested maximum pressure, for example set to 200 PSI, to ensure that the integrity of the tank is not compromised by overfilling. The tank would have a filling valve or nozzle (not shown), for example like that of an automotive tire, to pressurize it from a suitable compressed air source and a valved hose fitting 16 to connect it to a hot water tank 18. The hose fitting 16 is part of a connection line or conduit between the hollow interiors of the two tanks, and the shut off valve 20 on the fitting is operable to open and close this conduit to give selective control over pressurization of the water tank 18 by the compressed air from the air tank 12. Along the line or conduit from the pressure tank to the hot water tank is a regulator 22, which may be adjustable and that keeps the pressure down stream from the air tank within a suitable range for safe operation of the apparatus, for example between 20 and 40 PSI.

Next is the hot water tank 18, which has a selectively removable filler cap 24 that is removed to access a fill port or opening for filling the tank with water, for example standard household tap water, but that seals the water tank closed when fastened in place over the fill opening. For safety purposes, the water tank 18 also features a relief valve 25, for example set for 50 PSI, to prevent over pressurizing of the water tank beyond levels approaching its failure pressure. A valved whistle 26 is operatively installed atop the water tank 20 to sound when water in the tank is boiling, thereby providing an audible indication that the water has reached its intended level of heating and the unit is ready to use. The whistle features a closable valve 26a between it and the water tank's interior space so that when the apparatus is pressurized by opening of the shut-off valve 18 between the two tanks, hot water remaining steam are safely contained within the water tank and do not eject from the whistle opening. In the illustrated embodiment, the water tank relief valve 25 and whistle valve 26a are separate units installed on a common short pipe-like extension mounted atop the water tank in an upright position and communicating with the tank interior. The whistle opening 26 defined at or proximate the top end of this extension, with the relief valve positioned upstream of the whistle valve along the short pipe extension so as to function regardless of whether the whistle valve is opened or closed. Accordingly, when the whistle valve is closed, only the whistle is isolated; and the relief valve cannot be isolated from the tank pressure. The relief valve may be mounted elsewhere on the tank, but by having it on the same short pipe/line as the whistle, the rationale is that fewer holes in the pressurized water vessel means more strength and reliability, and less manufacturing expense.

In another embodiment, not illustrated, it may be possible to provide the functionality of the whistle valve and relief valve as a combined unit, for example a spring-biased relief valve with an adjustment knob, that when fully loosened exerts no spring-pressure on a lightweight valve element that will be displaced by steam pressure of the boiling water, but that when fully tightened to a predetermined maximum against a spring will exert a spring pressure on the valve element corresponding to the desired relief-pressure.

At the bottom of the water tank 20 is an electric heating element 32 to boil the water added to the tank. The electric heating element is externally powered by mains electricity through a power cord 34 equipped with a conventional male plug 36 at the cable end opposite the heating element 32 for selective mating with a household mains-power female outlet to couple the heating element to a power source separate and distinct from the weed poacher. A flexible pressure rated hose 38, which for example may be of a type like those used in hydraulic systems, is coupled to the water tank 20 at the bottom thereof to fluidly communicate with the water tank's interior to receive hot water therefrom for delivery onward to a “weed wand” 40 assembly secured to the opposite end of the hose.

The weed wand 40 is an elongate structure having an outer peripheral wall or sleeve 42 closing around the longitudinal axis of the wand over most of a length thereof. Within a hollow interior bound by the outer wall 42, a rigid length of pipe 44 lies on the longitudinal axis of the wand, extending from adjacent one end of the peripheral wall, where the rigid pipe is equipped with a fitting 46 to fluidly couple with the flexible hose 38, past the opposite end of the peripheral wall 42, where this projecting portion 44a of the rigid pipe marks the discharge end of the weed wand where the heated water exits the apparatus at the termination of the rigid pipe. An end portion 48 of the wand, where it connects to the flexible hose, defines a gripping portion of the wand where the user carries the wand by manually gripping around the peripheral wall.

The wand 40 has a quick valve 50 installed on the rigid pipe 44 and controlled by a lever assembly 52 that extends through an opening in the peripheral wall 42 from the valve thereinside. The lever assembly, after passing through the peripheral wall 42 extends toward the hose connected end of the wand so as to overlie the gripping portion 48 thereof. Depression of this handle portion of the lever assembly overlying the gripping portion of the wand's wall along the longitudinal axis causes the control valve 50 to open. This control valve allows full flow through the rigid pipe 44 with a slight pressure and travel, and is a normally closed valve that is biased by a spring or other resilient element to close off the pipe's bore or conduit unless the lever handle is depressed toward the wall of the wand. Accordingly, momentary displacement of the control lever handle out its normal position completes opening of the passage through the hose and pipe from the water tank to the discharge end of the wand where the water is ejected from the projecting end of the pipe under the exertion of the pressurized air from the compressed air tank against the heated water in the water tank.

At the end of the wand's peripheral wall 42 from which the pipe projects to the terminal end of the wand, a foot peg 54 projects radially outward from the peripheral wall 42 to allow the user's body weight to assist the driving of the terminal end of the delivery pipe 44 at the discharge end of the wand 40 into the ground to a suitable depth. At the very bottom of the wand and below the foot peg is the spike nozzle, which consists of the projecting portion of the pipe 44 and a series of triangular reinforcement plates or vanes 56 welded or otherwise fixed to the bottom end of the peripheral wall, for example at an end plate or other closure fixed on the peripheral wall and having a hole through which the pipe projects. The illustrated reinforcements are of right-angle triangular shape, with a shortest side fixed to the wall structure, a longer side fixed to the pipe, and the longest side or hypotenuse obliquely angling downward to taper the reinforcements to a point at the end of the projecting portion 44a of the pipe. The illustrated embodiment features four reinforcements equally spaced around the pipe at ninety-degrees apart from one another. The reinforcements prevent the pipe from bending, shearing or deflecting during insertion into the ground, while their tapered or spiked shape keeps the tip of the wand assembly narrow to better pierce the ground surface. Spacing apart of separate reinforcements reduces the area of the edges that resist piercing of the structure into the ground, as opposed to a frusto-conical tip that would present such resistive surface around the full perimeter of the pipe. In one preferred embodiment, the pipe is ¼-inch pipe and projects with the reinforcements 1½ inches from the rest of the wand. In another spike nozzle embodiment, the pipe is 1/16-inch pipe and projects with the reinforcements about 1-inch from the rest of the wand.

The hot water tank and all piping up to the spike nozzle are preferably insulated to minimize heat transfer to the user for safety and comfort. For compatibility with the environmentally-friendly chemical-free water-based weed extermination process, recycled denim may be selected as an insulation material. The two tanks may be mounted on or into a backpack, the straps of which can then be worn around the shoulders of the operator to carry the tanks on his or her back. The fittings used in the connection between the compressed air tank and water tank may allow selective disconnection of the two tanks, allowing the air tank to be separated from the rest of the apparatus for re-filling, for example therefore only requiring the one piece to be transported to a suitable filling station for cases where an owner/operator does not have their own suitable source of compressed air for filling of the tank. The filled air tank could incorporate a hose and filling nozzle/valve to facilitate use of the tank for compressed air needs other than operation of the weed poacher, for example for filling tires with air.

With a full tank of air connected and the pressure closed off to the hot water tank by the shut off valve, a user adds a suitable amount of water to the heating tank and open the whistle valve, so when the water boils, it will whistle and pressure will not build up. The user plugs in the heating element and when the water is boiling, opens the quick valve on the wand to allow steam/hot water pressure to vent out the spike nozzle, and shuts off the whistle valve. Then the user opens the shut-off valve on the connection conduit to the compressed air tank, to pressurize the hot water tank. With the quick valve held open, for example for thirty seconds or so, a stream of hot water will be squirting out of the spike nozzle, which will heat the line from the hot water tank to the spike nozzle. However, such a line-preheating step may not be necessary if heat loss from hot water traveling through an initially cool hose and pipe is not significant enough to cool the water to a temperature at which it is not sufficient to kill the weed's endosperm. The user then finds a weed, positions the wand and spike nozzle in the center of the weed, and steps on the foot peg to drive the spike into the ground. The user then depresses the quick valve lever to send near-boiling water directly to the endosperm of the weed.

The “Weed Poacher” directs a small but lethal dose of heat, as provided by the hot water, at the approximately gumball sized endosperm of the weed, typically located approximately 1 to 1½ inches below soil level. The fact that the user has enough control to limit the discharge to a finite, controlled amount of hot water means that kill area can be minimized to avoid unwanted damage to surrounding vegetation. The “spike nozzle” is preferably 1½ inches long, specifically designed to target the endosperm of typical weeds, with the reinforcing vanes or fins to stabilize the preferably ¼-inch nozzle, below the foot plate. The fact that the apparatus uses a variable amount of compressed air to force the hot water out of the spike nozzle, allows the user to control spike nozzle fouling or plugging by keeping the handle depressed long enough to build up sufficient pressure behind the blockage to eject it from the end of the spike nozzle, and allows adjustment for different soil conditions (sandy, clay, loam) through controlled operation of the release valve

The “Weed Poacher” is safe. There is no electrical connection when actually wearing and operating the unit, as the mains-powered heater is instead used to pre-heat the water, which is expected to be sufficient for most personal residential weed control applications. There is no propane or other fuel tank or burner, and no steam under pressure to worry about when the hose gets old as the whistle allows the steam to escape during the pre-heating process. The simple design can provide years of trouble free operation, with minimal maintenance, and may incorporate simple replaceable parts. For example, the spike nozzle may be a replaceable component selectively detachable from the end of the outer structure of the wand, in which case the wand may employ a separate length of pipe, hose or other conduit-forming structure inside the outer wall of the wand to which the spike nozzle threads or otherwise fastens onto at the bottom of the outer wall to abut thereagainst. The conduit through the outer wall may simply be the inner bore of the wall structure, with insulating material then provided at the exterior of the wall for comfort and safety.

An alternate embodiment may avoid the use of the built-in heater, and instead use pre-heated water from another source (e.g. boiled in an electric kettle or on the stove before adding to the tank). However, heating within the apparatus is preferred for safety (no pouring of boiling liquid) and to minimize cooling time of the water between heating and injection into the ground. In addition to the use of a backpack or other way of securing shoulder straps to the apparatus, other carrying options are possible for the intended single-person operation, and may include a simple carrying handle or a cart-like embodiment wheelable along the ground. Although the wand is shown as having a cylindrical wall or sleeve structure, it will be appreciated that the elongated shape of the wand may deviate from a purely linear configuration and the design of a suitable gripping or handle portion may likewise vary among different embodiments.

Also, where the delivery conduit is defined by a different piece than the outer shell, wall, or gripping-feature of the wand, the hose need not necessarily feed into the wand right at the and thereof, but it should be spaced from the discharge end so that the hose does not interfere with driving of this end into the earth. While the distance of the weed endosperm from the ground surface may vary, with user controlled dispensing of the heated water, an apparatus with a projecting nozzle/discharge portion of a length based on a deepest endosperm of expected typical weeds can still be operated to kill shallower weeds by piercing into the ground to a depth exceeding the endosperm depth (for example, piercing to the full length of the nozzle portion), then depressing the lever handle and keeping it depressed while slowly withdrawing the nozzle backward out of the ground. This way, water is being released over the full height of the injection site, and thus will directly contact the endosperm known to be positioned at some point therealong. In another application method found to effective in testing of a prototype by the applicant, the tip of the nozzle is placed on top of the weed at the centre (i.e. over where the weed emerges from the ground surface) and the wand valve is opened, at which time slight pressure is then used to push the tip down into the ground about ½-inch. The valve handle is then released to close the valve, and the nozzle tip is drawn upwardly out of the ground.

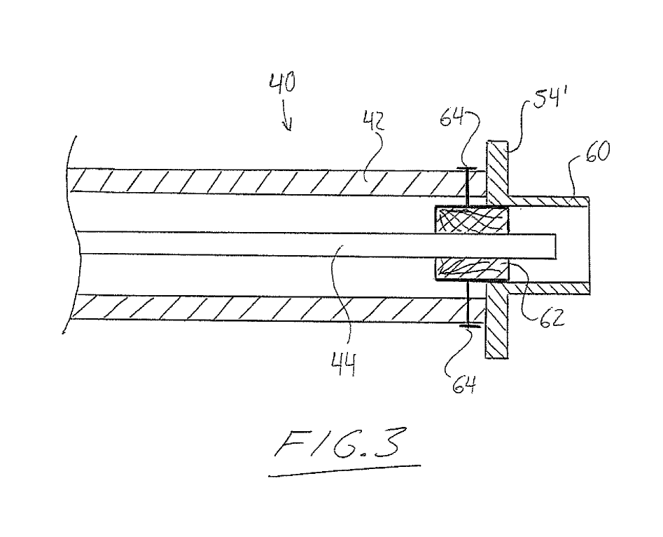

FIG. 3 illustrates a further embodiment that differs from that of FIGS. 1 and 2 primarily in the design of the nozzle at the discharge end of the wand. The weed wand 40 again features a cylindrical outer peripheral wall or sleeve 42, within which concentrically lies a rigid length of pipe 44 fluidly coupled to the flexible hose of the apparatus adjacent one end of the peripheral wall. Extending past the opposite end of the peripheral wall 42, a projecting portion 44a of the rigid pipe again marks the discharge end of the weed wand. A valve on the wand is operable in the same manner as the first embodiment to control flow through the pipe conduit in the wand.

At the end of the wand's peripheral wall 42 from which the pipe projects to the terminal end of the wand, a foot plate 54′ again projects radially outward from the peripheral wall 42, but in this embodiment is an annular plate extending fully around the outside of the peripheral wall 42 to allow stepping of a user's foot onto it from any side or direction. A hollow cylindrical collar or socket 60 project axially from the annular plate 54′ to a side thereof opposite the cylindrical peripheral wall 42 of the wand in co-axial alignment therewith. The socket 60 has an outer diameter smaller than that of the peripheral wall. The rigid pipe 44 projects past the end of the peripheral wall, through the central hole in the annular foot plate 54′ and into the hollow interior of the socket 60, stopping a distance short of the distal end 60a of the socket furthest from the foot plate 54′. Accordingly, when heated water is ejected from this discharge end at the portion 44a of the pipe projecting out from the outer peripheral wall 42, it does so within the confines of the annular wall defined by the cylindrical socket 60. The socket wall acts as a fence to contain the pressurized water/steam being injected into the ground through the pipe 44 by limiting radially outward travel or expansion thereof through the soil at the discharge end of the pipe. This socket nozzle thus better directs the heated water/steam to the targeted weed, and minimizes inadvertent damage to surrounding vegetation.

At a distance spaced from the discharge end of the pipe, a cylindrical block of insulation 62 spans the annular space between the inner pipe 44 and the surrounding foot plate and collar assembly 54′, 60. In the illustrated socket nozzle, the foot plate and socket are integral parts of a unitary structure containing a central cylindrical through-bore defining the foot plate aperture, and the open ends and hollow interior of the socket 60, and the insulation block 62 axially spans from near the outer face of the foot plate (i.e. the side of the foot plate facing away from the peripheral wall 42) and into the hollow interior of the wand's peripheral wall 42 past the opposing inner face of the foot plate at the respective end of the peripheral wall. A short distance from the foot plate 54′ along the axis of the peripheral wall 42, a pair of fasteners 64 engage into the insulation block 62 through diametrically opposite radial holes in the peripheral wall 42 to secure the insulation block in place at the by biting into the insulation block to prevent movement thereof along the shared axis of the peripheral wall, internal pipe 44, and foot plate and socket assembly 54′, 60.

The inner pipe 40 of the socket nozzle preferably extends between ¼-inch and ½-inch past the outer face of the foot plate, with the socket 60 preferably extending ¾-inch to 1-inch from the outer face of the foot plate. A prototype socket nozzle features inner pipe 44 that is ¼-inch in diameter and projects about ⅓-inch past the outer face of the foot plate, and that employs a wooden insulation plug that is held in place by a pair of screws threading radially thereinto through a diametric bore in the peripheral wall and is sealed at its outer face with a coating of silicone sealant. The prototype features a collar with a of 1-inch outer diameter and a ¾-inch axial length projecting from the foot plate, and employs a 1.5-inch outer diameter pipe as the wand's peripheral wall. These dimensions and materials are presented in an exemplary context only, and do define limit the scope of the present invention to these particular dimensional values and material selections.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for killing unwanted vegetation using heated water, the apparatus comprising:
a refillable compressed air tank;
a refillable water tank connected to the refillable compressed air tank by a connection conduit and having an openable and closeable fill opening for filling of the water tank;
a shut-off valve operably installed on the connection conduit between the compressed air tank and the water tank for select opening and closing of the conduit to respectively allow and prevent flow between the tanks;
a flexible hose having a first end thereof connected to the water tank;
an applicator wand connected to a second end of the flexible hose opposite the water tank and comprising a rigid delivery conduit terminating at a discharge end of the applicator wand spaced along the wand from a connection of the flexible hose thereto, the flexible hose and the rigid delivery conduit being fluidly coupled together in a sealed condition to allow flow from the flexible through the rigid delivery conduit for exit therefrom at the discharge end of the applicator wand; and
a normally closed control valve operable to selectively and temporarily open from a normally closed position blocking flow through the flexible hose and the rigid conduit to control discharge of heated water from the water tank under air pressure from the air tank.

2. The apparatus of claim 1 further comprising an electric heater device mounted on the water tank and operable to heat water contained therein.

3. The apparatus of claim 2 wherein the electric heater device is arranged to be powered by an external power source separate and distinct from the apparatus.

4. The apparatus of claim 2 wherein the electric heater device comprises a power cord equipped with a male plug at an end thereof opposite the water tank to mate with a female mains power socket for operation of the heater device.

5. The apparatus of claim 2 wherein the electric heater device comprises an electric element disposed within an interior of the water tank.

6. The apparatus of claim 2 comprising an indicator device on the water tank operable to indicate when the water contained in the water tank has been heated sufficiently for use of the apparatus.

7. The apparatus of claim 6 wherein the indicator device comprises a steam whistle providing an audible indication when the water has reached a boil.

8. The apparatus of claim 7 comprising a whistle valve operable to open and close a passage between the interior of the water tank and the whistle to enable closing of the water tank after the water has boiled but before the shut off valve is opened to expose the water to pressure from the compressed air tank.

9. The apparatus of claim 1 comprising straps by which the compressed air and water tanks can be carried by an operator.

10. The apparatus of claim 9 wherein the straps are part of a back pack on which the compressed air and water tanks are carried.

11. The apparatus of claims 1 wherein the wand comprises an outer wall closing around the rigid conduit over at least a partial length thereof and reinforcements mounted between the rigid conduit and an end of the outer wall from which a portion of the rigid conduit projects to the discharge end to reinforce said portion of the rigid conduit during piercing thereof into ground to inject heated water thereto.

12. The apparatus of claim 1 comprising a socket fixed to the wand in a position closing around the rigid conduit at the discharge end of the wand and projecting past the discharge end of the wand so that the rigid conduit discharges into a hollow interior of the socket.

13. The apparatus of claim 12 wherein the wand comprises an outer wall closing around the rigid conduit over at least a partial length thereof, the socket being connected to the outer wall at and end thereof adjacent the discharge end of the wand and being smaller in outer diameter than the outer wall.

14. The apparatus of claim 1 wherein the wand comprises a foot projection extending outward from a remainder of the wand at a position therealong proximate but spaced from the discharge end to present a feature against which an operator's foot can be pushed to drive the discharge end of the wand into a spot of ground at which undesired vegetation has grown.

15. The apparatus of claim 1 wherein the rigid conduit is between 1/16-inch and ¾-inch in diameter, inclusive.

16. Method for killing unwanted vegetation using heated water, the method comprising injecting heating water and injecting the heated water beneath a spot of ground from which the unwanted vegetation has emerged.

17. The method of claim 16 comprising injecting the heated water at a depth beneath ground surface at which an endosperm of the unwanted vegetation is disposed.

18. The method of claim 16 comprising injecting the heated water at a depth of less than 2-inches beneath ground surface.

19. The method of claim 16 comprising piercing a discharge end of an injector through ground surface to a depth below an endosperm of the unwanted vegetation, beginning to inject the heated water and continuing to inject the heated water while withdrawing the discharge end of the injector back toward the ground surface.

20. The method of claim 16 comprising:
obtaining an apparatus having a refillable compressed air tank, a refillable water tank connected to the refillable compressed air tank by a connection conduit, a shut-off valve operably installed on the connection conduit, a flexible hose having a first end thereof connected to the water tank, an applicator wand connected to a second end of the flexible hose opposite the water tank and comprising a rigid delivery conduit coupled to the flexible hose and terminating at a discharge end of the applicator wand, and a normally closed control valve operable to selectively and temporarily open from a normally closed position blocking flow through the flexible hose and the rigid conduit to control discharge of heated water from the water tank under air pressure from the air tank; and
using the apparatus to inject the heated water by opening the shut off valve to expose the heated water in the water tank to compressed air from the compressed air tank, piercing the discharge end of the wand into ground, and opening the normally closed control valve to release some of the heated water from the apparatus through the rigid conduit at the discharge end of the wand.
